(19) United States
(12) Patent Application Publication
(10) Pub. No.: US 2026/0319891 A1
(43) Pub. Date: Oct. 15, 2026

(54) PERSISTENT FATAL FAULT LOGGING IN X86 CPUS ON BOARDS WITHOUT A BASEBOARD MANAGEMENT CONTROLLER (BMC)

(71) Applicant: Cisco Technology, Inc., San Jose, CA (US)

(72) Inventors: Saurabh Jain, Milpitas, CA (US); Todd Otake, Cambell, CA (US)

(21) Appl. No.: 19/176,987

(22) Filed: Apr. 11, 2025

(51) Int. Cl. G06F 11/14; G06F 11/07

(52) U.S. Cl. CPC G06F 11/1417; G06F 11/0787; G06F 2201/84

(57) ABSTRACT

The disclosed technology uses a warm reset to log fault data in persistent memory when recovering from a fatal fault event (also called a catastrophic error or CATERR) in a computing system including a processor, a basic input/output system (BIOS), and a state controller (e,g., CPU-state logic controlling the processor state). Responsive to the CATERR, the processor causes the state controller to enter a power-cycle-holdoff state while fault collection and logging is performed by the BIOS. The warm reset restores the processor to a non-fault state while preserving fault data in registers within the processor (e.g., machine check architecture banks and other registers storing fault data), enabling the BIOS to collect and log the fault data in persistent memory (e.g., serial peripheral interface flash), after which the state controller causes the system to be power cycled.

### BACKGROUND

In at least some ×86 central processing units (CPUs), a fatal CPU fault (also called a catastrophic error or CATERR) generates little failure data for performing a post-mortem analysis on the CATERR. The fault data available can be limited to the data the machine check (MC) handler running on one of the CPU cores can collect and send to a collector application running on another core to write it into persistent storage. In many CATERR cases, the CPU cores become completely stuck (e.g., unable to run at all) or are otherwise unable to persist any data via the I/O controllers. To get around this problem, CPU systems can use a separate Baseboard Management Controller (BMC) to detect the CATERR event and collect fault data via out-of-band (OOB) interfaces.

The Baseboard Management Controller (BMC) is a specialized microcontroller embedded on the motherboard of ×86 CPUs, such as in servers and high-performance computing systems. The BMC provides OOB management, allowing administrators to monitor, manage, and troubleshoot the system even when the operating system is not running. The BMC operates independently from the main CPU and can access system components like sensors, power supplies, and fans, offering features such as remote power cycling, hardware health monitoring, and system event logging. The BMC can interface with the Intelligent Platform Management Interface (IPMI). Through the BMC, administrators can remotely access the server's console, perform diagnostics, and update firmware.

### BRIEF DESCRIPTION OF THE SEVERAL VIEWS OF THE DRAWINGS

In order to describe the manner in which the above-recited and other advantages and features of the disclosure can be obtained, a more particular description of the principles briefly described above will be rendered by reference to specific embodiments thereof, which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates a block diagram of an example of a system with a processor having a system management unit (SMU) for logging processor fault data in persistent memory in accordance with some embodiments.

FIG. 2 illustrates a flow diagram of an example of a method for logging CPU fault data in persistent memory using a processor with an SMU in accordance with some embodiments.

FIG. 3 illustrates a block diagram of an example of a system for logging processor fault data in persistent memory using a processor without an SMU in accordance with some embodiments.

FIG. 4 illustrates a flow diagram of an example of a method for logging CPU fault data in persistent memory using a processor without an SMU in accordance with some embodiments.

FIG. 5A and FIG. 5B illustrate examples of computing systems in accordance with some embodiments.

### DESCRIPTION OF EXAMPLE EMBODIMENTS

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

### Overview

In some aspects, the techniques described herein relate to a method for recovering from a fatal fault event (also referred to as a catastrophic error or CATERR), the method including: obtaining, at a processor, a fatal-fault-event signal indicating a fault state occurred within a system of the processor; sending, from the processor to a state controller, one or more first signals indicating an occurrence of the fault state, the one or more first signals causing the state controller to be in a power-cycle-holdoff state; and performing a warm reset of the processor by: causing, in response to the fatal-fault-event signal, an execution of a part of a boot sequence that restores the processor to a non-fault state while preserving fault data in registers within the processor; collecting, by a BIOS (basic input/output system), the fault data in the registers; and logging the fault data in a persistent memory storage.

In some aspects, the techniques described herein relate to a method, wherein: the persistent memory storage is a serial peripheral interface flash memory, the processor is an ×86 central processing unit (CPU), the registers include machine check architecture banks; and the state controller is a finite state machine that having CPU-state logic encoded in a field programable gate array, an application specific integrated circuit, or a combination of discrete logic components.

In some aspects, the techniques described herein relate to a method, further including: sending, from the processor to the state controller, a second signal upon completion of the warm reset, the second signal indicating that the collecting of the fault data and the logging of the fault data is complete, wherein sending the one or more first signals to the state controller indicates that the fault state is the fatal fault event.

In some aspects, the techniques described herein relate to a method, further including: sending, from the processor to the state controller, a second signal upon completion of the warm reset, the second signal indicating that the warm reset is complete, wherein sending the one or more first signals to the state controller indicates that the fault state is the CATERR.

In some aspects, the techniques described herein relate to a method, further, including: timing, by the state controller, a duration from when the one or more first signals are received at the state controller; and transitioning the state controller from the power-cycle-holdoff state to a power-cycle-allowed state indicating an end to holding off power cycling the system of the processor, wherein the state controller is transitioned to the power-cycle-allowed state in response to at least one of the duration exceeding a predefined timeout value or receiving the second signal at the state controller.

In some aspects, the techniques described herein relate to a method, further including: receiving, from the state controller to the processor, an instruction to power cycle the system of the processor, wherein the system of the processor is a single-card system having one card to which the processor is fixed.

In some aspects, the techniques described herein relate to a method, further including: receiving, at a master controller from the state controller, a third signal indicating that the fatal-fault-event signal (e.g., CATERR signal) was obtained; and in response to the third signal performing, by the master controller, steps of: writing the fault data from the persistent memory storage to a system storage, and receiving, at the processor from the master controller, an instruction to power cycle a card of the processor, wherein the system of the processor is a multi-card system having two or more cards including the card of the processor.

In some aspects, the techniques described herein relate to a method, further including: receiving, at firmware of the processor, an indicator that the BIOS has a functionality to collect the fault data; responsive to the indicator, enabling a warm reset to be triggered upon receiving the fatal-fault-event signal, and receiving, at the firmware, the fatal-fault-event signal and, in response to receiving the fatal-fault-event signal, triggering the warm reset and indicating to BIOS that the warm reset has been triggered to cause the collecting and logging of the fault data upon a subsequent boot iteration, wherein the one or more first signals are sent to the state controller in response to the firmware receiving the fatal-fault-event signal.

In some aspects, the techniques described herein relate to a method, further including: receiving, at firmware of the processor, an indicator from BIOS that system is configured to do warm reset upon fatal fault; and receiving, at the firmware, the CATERR signal and, in response to receiving the CATERR signal, triggering the warm reset either via firmware (e.g., when the SMU is present) or via the CPU state controller, wherein the one or more first signals are sent to the state controller in response to the firmware receiving the CATERR signal.

In some aspects, the techniques described herein relate to a method, further including: sending, from the processor to the state controller, a second signal upon completion of the warm reset, the second signal includes toggling a voltage on a general-purpose input/output pin to high, wherein the one or more first signals are sent to the state controller in response to the processor obtaining the CATERR signal, and the one or more first signals include an alert signal and reset signal.

In some aspects, the techniques described herein relate to a method, further including: sending, from the processor to the state controller, a second signal upon completion of the collecting of the fault data and the logging of the fault data, the second signal includes toggling a voltage on a general-purpose input/output pin to high, wherein the one or more first signals are sent to the state controller in response to the processor obtaining the fatal-fault-event signal, and the one or more first signals include an alert signal and reset signal.

In some aspects, the techniques described herein relate to a method, wherein performing the part of the boot sequence includes that the part of the boot sequence omits a part of a full boot sequence accessing input/output data from components outside of the processor and the part of the boot sequence omits parts of the full boot sequence in which the processor accesses data from one or more peripheral component interconnect express devices that have not been reset since the fault state occurred.

According to certain non-limiting examples, the warm reset is triggered either via an SMU (when the SMU is available) or via a central processing unit (CPU) state controller for restoring the processor to a non-fault state and preserving fault data saved in fault registers within the processor. Further, prior to collecting the fault data in the fault registers, the method can maintain a state in the SMU or in the CPU state controller, wherein the state indicates that a fault occurred and that the fault caused the warm reset to be performed, and providing the state to the BIOS to inform the BIOS of the state during the part of boot sequence.

In some aspects, the techniques described herein relate to a method, wherein: the warm reset of the processor is triggered either by warm reset of the processor either via a system management unit (SMU) provided in firmware of the processor or by the state controller, and the registers are fault registers.

In some aspects, the techniques described herein relate to a method, further including signaling that the system of the processor is ready to be power cycled by: de-asserting, by the state controller, a processor-ready status, and asserting, by the state controller, a fatal-fault-event status.

In some aspects, the techniques described herein relate to a computing system that recovers from a CATERR (catastrophic error), the computing system including: a processor executing a BIOS (basic input/output system); a state controller including CPU-state logic that controls a state of the processor; a plurality of memories including a persistent memory and a BIOS memory; and the plurality of memories storing instructions that, when executed by the processor, configure the computing system to: obtain, at the processor, a CATERR signal indicating a fault state occurred within the computing system; sending, from the processor to the state controller, one or more first signals indicating an occurrence of the fault state, the one or more first signals causing the state controller to be in a power-cycle-holdoff state; and sending, from the processor to a state controller, one or more first signals indicating an occurrence of the fault state, the one or more first signals causing the state controller to be in a power-cycle-holdoff state; perform a warm reset of the processor in response to the fatal fault thereby recovering it to a non-fault state with fault registers preserved, collect and log, by the BIOS, the fault data in a persistent memory storage.

In some aspects, the techniques described herein relate to a computing system, wherein the computing system is configured to perform warm reset of the computing system by: performing, in response to the CATERR signal, a first part of a boot sequence restoring the processor to a non-fault state and preserving fault data in first registers within the processor, collect, by the BIOS, the fault data in the first registers, and log the fault data in a persistent memory storage. .

In some aspects, the techniques described herein relate to a computing system, wherein: the persistent memory storage is a serial peripheral interface flash memory, the processor is an ×86 central processing unit (CPU), the fault registers include machine check architecture banks; and the state controller is a finite state machine that having CPU-state logic encoded in a field programable gate array, an application specific integrated circuit, or a combination of discrete logic components.

In some aspects, the techniques described herein relate to a computing system, wherein the computing system is configured to signal that the computing system is ready to be power cycled by state logic, causing the state controller to de-assert a processor-ready status and assert a CATERR status.

In some aspects, the techniques described herein relate to a computing system, wherein the instructions further configure the computing system to: send, from the processor to the state controller, a second signal upon completion of the warm reset, the second signal indicating that the warm reset is complete, wherein sending the one or more first signals to the state controller indicates that the fault state is the CATERR.

In some aspects, the techniques described herein relate to a computing system, wherein the state controller is configured to: time, by the state controller, a duration from when the one or more first signals are received at the state controller; the state controller from the power-cycle-holdoff state to a power-cycle-allowed state indicating an end to holding off power cycling the computing system, wherein the state controller is transitioned to the power-cycle-allowed state in response to at least one of the duration exceeding a predefined timeout value or receiving the second signal at the state controller.

In some aspects, the techniques described herein relate to a computing system, wherein the instructions further configure the computing system to: receive, from the state controller to the processor, an instruction to power cycle the computing system, wherein the computing system is a single-card system having one card to which the processor is fixed.

In some aspects, the techniques described herein relate to a computing system, wherein the instructions further configure the computing system to: receive, at firmware of the processor, an indicator that the BIOS has a functionality to collect and log fault data persistently upon performing the warm reset; and receive, at the firmware, the CATERR signal and, in response to receiving the CATERR signal, send an instruction to the BIOS that a warm reset due to fault occurred, wherein the one or more first signals are sent to the state controller in response to the firmware receiving the CATERR signal.

In some aspects, the techniques described herein relate to a computing system, wherein the instructions further configure the computing system to: send, from the processor to the state controller, a second signal upon completion of the warm reset, the second signal includes toggling a voltage on a general-purpose input/output pin to high, wherein the one or more first signals are sent to the state controller in response to the processor obtaining the CATERR signal, and the one or more first signals include an alert signal and reset signal.

In some aspects, the techniques described herein relate to a computing system, wherein performing the first part of the boot sequence includes that the first part of the boot sequence omits a part of a full boot sequence accessing input/output data from components outside of the processor and the first part of the boot sequence omits parts of the full boot sequence in which the processor accesses data from one or more peripheral component interconnect express devices that have not been reset since the fault state occurred.

In some aspects, the techniques described herein relate to a non-transitory computer-readable storage medium, the non-transitory computer-readable storage medium including instructions for recovering from a catastrophic error (CATERR) that when executed by a computing system, cause the computing system to: obtain a CATERR signal indicating a fault state occurred within the computing system, the computing system including a processor; send, from the processor to a state controller, one or more first signals indicating an occurrence of the fault state, the one or more first signals causing the state controller to be in a power-cycle-holdoff state; and perform, by a BIOS (basic input/output system), a warm reset of the processor by: performing, in response to the CATERR signal, a first part of a boot sequence restoring the processor to a non-fault state and preserving fault data in first registers within the processor; collecting, by the BIOS, the fault data in first registers; and logging the fault data in a persistent memory storage.

In some aspects, the techniques described herein relate to a non-transitory computer-readable storage medium, the non-transitory computer-readable storage medium including instructions for recovering from a catastrophic error (CATERR) that when executed by a computing system, cause the computing system to: obtain a CATERR signal indicating a fault state occurred within the computing system, the computing system including a processor; send, from the processor to a state controller, one or more first signals indicating an occurrence of the fault state, the one or more first signals causing the state controller to be in a power-cycle-holdoff state; and perform a warm reset of the processor in response to the fatal fault thereby recovering it to a non-fault state with fault registers preserved, collect and log, by the BIOS, the fault data in a persistent memory storage during the first part of the boot sequence with full boot sequence omitted.

### Example Embodiments

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

The disclosed technology addresses the need in the art for handling catastrophic errors (CATERRs) to collect and persistently store fault data, thereby enabling more effective post-mortem analysis of the CATERRs.

In the event of a CATERR, the systems and methods disclosed herein use a combination of a warm reset together with an intermediate holdoff state that delays power cycling the CPU until after the warm reset. The warm reset enables the BIOS to partially reboot the CPU, restoring to a non-fault state while preserving the fault data in respective registers on the CPU. Thus, the fault data can be collected and stored in persistent memory, before the CPU is power cycled.

As discussed above, in previous ×86 CPUs without a Baseboard Management Controller (BMC), a CATERR would provide little fault data for a post-mortem analysis because the fault data was limited to the data the machine check (MC) handler was able to collect. In many failure cases, the CATERR results in the CPU cores being completely stuck (e.g., unable to run at all) or being able to run but unable to persist any data via the I/O controllers. In some cases, the CATERR resulted in a complete lack of fault data because the CPU cores either became completely stuck or were otherwise unable to persist any data via the I/O controllers.

In previous ×86 CPUs with a BMC, the BMC is used to detect the CATERR event and collect fault data via out-of-band (OOB) interfaces. However, even with the BMC, some CATERRs result in CPU states that prevent the internal logic and internal buses from accessing the fault data stored in the Machine Check Architecture (MCA) banks.

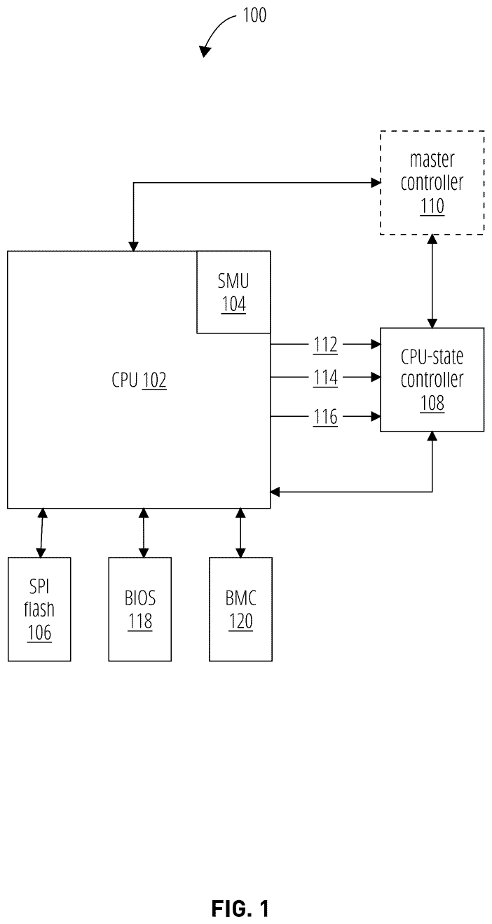

FIG. 1 illustrates a non-limiting example of system 100 including a processor or central processing unit (e.g., CPU 102), a system management unit (e.g., SMU 104), a serial peripheral interface flash (e.g., SPI flash 106), CPU-state controller 108), a Basic Input/Output System (e.g., BIOS 118), and a Baseboard Management Controller (e.g., BMC 120).

CPU 102 communicates with CPU-state controller 108 by sending various signals and communications to CPU-state controller 108, including, for example, ALERT_L 112, RESET_L 114, and a signal on the General Purpose Input/Output pin (e.g., GPIO 116). Further, CPU 102 can connect to master controller 110, which is optional. In a modular system with multiple cards in addition to the card that includes CPU 102, master controller 110 can be used to control and coordinate the respective cards.

CPU 102 can experience a fatal fault for various reasons. For example, a fatal fault can be the result of a malfunction within a device or due to a malfunction of a component on the board whose access might hang the device. When this occurs, a warm reset is performed by a combination of the BIOS 118 and CPU-state controller 108. During the warm reset, persistent fault data is gathered and stored to enable a post-mortem on what caused the fatal fault. In the warm rest, CPU-state controller 108 functions as a state machine managing the warm rest process, and BIOS 118 provides additional functionality that contributes to triggering the warm reset and gathering fault data while in the warm-reset state.

For example, upon the detection of a catastrophic error (CATERR), a warm reset can be performed instead of a cold reset. The warm reset enables the collection and storage of fault data, which cannot be collected in other ways, as discussed above. In a warm reset, the board is suspended in a transient state by BIOS 118 performing a first part of its boot cycle but then holding off the remaining portion of the boot cycle. This transient state revives the logic back to a good state from the fault state. This revival of the logic to a good state (i.e., a non-fault state) can be done without losing the state of the machine check architecture (MCA) banks, enabling BIOS 118 to collect the fault data from the MCA banks, as well as additional registers. By holding off the remainder of the boot cycle, the warm reset avoids accessing input and output (I/O) outside CPU 102, which could cause the fault to recur. Although the first part of its boot cycle returns the logic on CPU 102 to a good state, it does not return other components to a good state. Because the other components on the board (especially the peripheral component interconnect express (PCIe) devices) have not gone through a reset, accessing the other components could cause another fatal fault on CPU 102. For example, if the fault is due to another component on the board, accessing I/O from that component could cause BIOS 118 to hang up again, resulting in a recurrence of the fault state. To prevent this, the transient state provided by the warm reset avoids access to I/O off of the CPU, when possible, until the CPU fault data has been collected. According to certain non-limiting examples, the fault collection and storing of the collected fault data to persistent memory are performed by a platform BIOS before the peripheral component interconnect express (PCIe) enumeration phase in the Driver Execution Environment (DXE), in contrast to the boot process in the standard Linux kernel.

While in the transient state of the warm restart, BIOS 118 collects the fault data from CPU 102, and the fault data is stored on SPI flash 106. Once BIOS 118 has completed the fault collection, BIOS 118 signals to CPU-state controller 108 that the fault condition was detected by punching the GPIO pin (e.g., GPIO 116). Upon receiving the signal on the GPIO pin, CPU-state controller 108 can initiate a full reset of the card (e.g., by de-asserting and the CPU ready (CPU_RDY) status and asserting a CATTERR status). The process for resetting the system can depend on the type of card on which CPU 102 is located. On the one hand, in a modular system with multiple cards, CPU-state controller 108 can signal the CATERR to master controller 110, and master controller 110 can control power cycling the card. On the other hand, in a single-card system, CPU-state controller 108 controls when the card is power cycled.

According to certain non-limiting examples, SMU 104 can communicate the CATERR to CPU-state controller 108 by asserting both an alert signal and a reset signal (e.g., ALERT_L 112 and RESET_L 114). After receiving this communication, CPU-state controller 108 recognizes that a warm reset is being performed and waits until an additional signal on GPIO 116 is received, signaling that the warm reset is complete and the fault data has been stored, before initiating the process of power cycling the card. To avoid a scenario in which asserting the alert signal and the reset signal (e.g., ALERT_L 112 and RESET_L 114) fail to be asserted for some reason thereby causing CPU-state controller 108 to perpetually wait, and system 100 to be hung up, CPU-state controller 108 can start a timer upon triggering the warm reset, and, when the timer exceeds a predefined timeout value, CPU-state controller 108 transitions to the power-cycle-allowed state.

According to certain non-limiting examples, CPU 102 is an ×86 CPU, and CPU 102 has an internal micro-controller that is separate from the actual ×86 CPU cores. This controller can be referred to as the System Management Unit (SMU), and the SMU runs on dedicated Firmware (FW). When any of the ×86 cores or any Internal bus logic or I/O controllers detect a catastrophic (CATERR), the SMU FW receives an event. For example, the SMU can assert the ALERT_L and RESET_L signals (e.g., set to voltage on the respective pins to high), informing CPU-state controller 108 about this event and requesting the card be power cycled. However, rather than immediately power cycling the card, CPU-state controller 108 enters a holdoff state in which it waits for BIOS 118 to perform a warm reset to collect fault data on CPU 102. For example, the SMU FW (e.g., SMU 104) triggers the warm reset of the CPU. Additionally, in response to seeing a combination of assertion on ALERT_L and RESET_L signals, CPU-state controller 108 holds off doing an immediate card power cycle. The use of the warm reset revives the logic of CPU 102 back to a good state (from the fault state) without losing the state of the MCA banks. Thus, the warm reset enables read-back support of the fault data.

According to certain non-limiting examples, CPU-state controller 108 is a finite state machine that has CPU-state logic encoded in a field programable gate array (FPGA), an application specific integrated circuit (ASIC), or a combination of discrete logic component

Further, during the warm reset, access to any I/O outside of the CPU is avoided until all the CPU fault data has been collected. Generally, the rest of the components on the board (especially peripheral component interconnect express (PCIe) devices) have not gone through reset and may potentially cause CATERR to recur, if the component that caused the original CATERR is accessed. To mitigate against the CATERR recurring, the collecting and storing of the fault data in persistent memory is performed in platform BIOS (before peripheral component interconnect express (PCIe) enumeration phase in DXE), in contrast to the boot sequence performed using the standard Linux kernel.

Serial Peripheral Interface (SPI) Flash is a type of non-volatile memory storage that uses the SPI protocol for data communication. For example, SPI flash 106 can be controlled a microcontroller or processor that acts as the master, and the flash memory chip functions as the slave. The SPI protocol can provide fast data transfer for devices such as routers or other devices that can benefit from their small form factor and low power consumption. Additionally, SPI Flash offers high read speeds and moderate write speeds.

SMU 104 can be a firmware component that controls aspects of CPU 102. For example, firmware, SMU 104 can be embedded within the CPU to interact directly with the hardware to control power states, thermal management, voltage regulation, and other low-level operations. SMU 104 can monitor system sensors, such as temperature and power consumption. Further, SMU 104 can play a role in handling error detection, system diagnostics, and protecting the CPU from overcurrent or overheating situations. As discussed above, SMU 104 can receive signals from CPU 102 indicating that a CATERR has occurred. In this case, SMU 104 can trigger warm reset with preconfigured indication from BIOS 118 and can also inform BIOS 118 post warm reset that the boot iteration was a result of fault triggered warm reset as opposed to cold reset.

BIOS 118 can be a firmware interface that initializes and tests hardware components during the boot process. For example, BIOS 118 can reside in a chip on the motherboard. BIOS 118 can perform POST (Power-On Self Test), which checks the integrity of essential hardware like memory, the processor, and storage devices before the operating system loads. BIOS 118 can also provide a low-level interface between the operating system and the computer's hardware, enabling communication between the two.

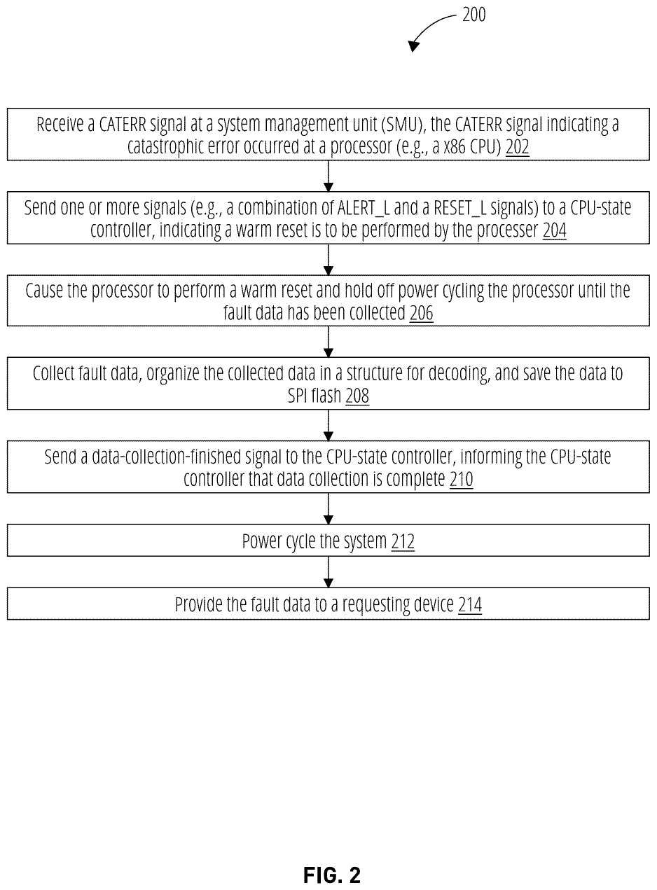

FIG. 2 illustrates an example method 200 for collecting CPU fault data using a warm reset for system 100. Although the example method 200 depicts a particular sequence of operations, the sequence may be altered without departing from the scope of the present disclosure. For example, some of the operations depicted may be performed in parallel or in a different sequence that does not materially affect the function of method 200. In other examples, different components of an example device or system that implements method 200 may perform functions at substantially the same time or in a specific sequence.

According to some examples, step 202 of the method includes receiving a CATERR signal at a system management unit (SMU), the CATERR signal indicating a catastrophic error occurred at a processor (e.g., a ×86 CPU). For example, SMU 104 illustrated in FIG. 1 may receive a CATERR signal that indicates a catastrophic error occurred at CPU 102.

According to some examples, step 204 of the method includes sending one or more signals to a CPU-state controller, indicating a warm reset is performed by the processer. For example, CPU 102 illustrated in FIG. 1 may send a combination of ALERT_L 112 and RESET_L 114 signals to CPU-state controller 108, indicating a warm reset is performed.

According to some examples, step 206 of the method includes causing the processor to perform a warm reset and holding off power cycling the processor until the fault data has been collected. For example, SMU 104 illustrated in FIG. 1 may trigger the warm reset with a preconfigured indication from BIOS 118 and CPU-state controller 108 can hold off power cycling the processor until fault data has been collected.

According to some examples, step 208 of the method includes collecting fault data, organize the collected data in a structure for decoding, and save the data to SPI flash. For example, BIOS 118 illustrated in FIG. 1 may collect the fault data, organize the collected data in a structure for decoding, and save the data to SPI flash 106. BIOS 118 can perform part of a boot sequence to revive the logic back of CPU 102 to a good state (from the fault state) without losing the state of the MCA banks. This enables read-back support of the fault data. Additionally, during the warm reset, access to any I/O outside of the CPU is avoided until the collection of the CPU fault data is complete, as discussed above.

According to some examples, step 210 of the method includes sending a data-collection-finished signal to the CPU-state controller, informing the CPU-state controller that data collection is complete. For example, CPU 102 illustrated in FIG. 1 may send a data-collection-finished signal (e.g., GPIO 116) to CPU-state controller 108, informing CPU-state controller 108 that the collection of the CPU fault data is complete.

According to some examples, step 212 of the method includes power cycling the system. For example, in the case that CPU 102 is in a single-card system. CPU-state controller 108 illustrated in FIG. 1 may power cycle the system. Alternatively, CPU 102 is in a modular system with multiple cards (e.g., a multi-card system), CPU-state controller 108 can signal to master controller 110 that the card on which CPU 102 is located should be power cycled, and master controller 110 can power cycle the card on which CPU 102 is located. fixed

According to certain non-limiting examples, a timer and a predefined timeout value can be used to avoid a scenario in which asserting ALERT_L 112 and RESET_L 114 fail to be asserted for some reason. In the absence of the predefined timeout value the CPU-state controller 108 may be caught in a state of perpetually waiting for ALERT_L 112 and RESET_L 114 to be asserted, hanging up system 100. To avoid this, CPU-state controller 108 can start a timer upon triggering the warm reset, and, when the timer exceeds a predefined timeout value, CPU-state controller 108 transitions to the power-cycle-allowed state.

That is, either the CPU-state controller or a master controller cycles the system, depending on the type of system. In a system with a single card, the CPU-state controller can power cycle the system. For example, when the system has a single CPU, the power cycle is initiated by the hardware state machine, which acts autonomously.

However, in a modular system with multiple cards (e.g., more than one CPU systems), a master CPU can transfer the fault information from the failed CPU to a local disk drive or even remote storage. After the transfer is complete, the master CPU, as opposed to the CPU-state controller, initiates the power cycle. According to certain non-limiting examples, the master controller can power cycle just the faulty card with the catastrophic error, rather than power cycling the entire modular system, For example, the master control can save the fault data in the SPI flash of the faulty card to a solid state drive (SSD), and the master controller use its awareness of the status of other cards in the system to coordinate the power cycling to not adversely affect the other cards.

According to some examples, step 214 of the method includes providing the fault data to a requesting device. For example, SPI flash 106 illustrated in FIG. 1 may send the fault data to the requesting device.

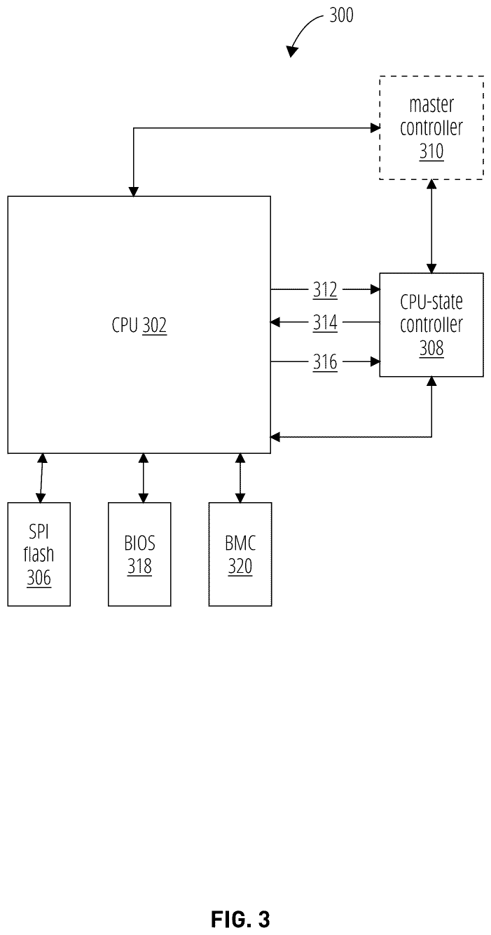

FIG. 3 illustrates a non-limiting example of system 300 that is similar to system 100, except system 300 lacks SMU 104. In this case, CPU-state controller 308 triggers the warm reset signal (e.g., WARM_RESET 314) upon receiving a CATERR indication, on systems where BIOS 318 supports fault data collection to a dedicated SPI flash 306. System 300 includes CPU 302, SPI flash 306, CPU-state controller 308, BMC 320, and master controller 310 (if CPU 302 is part of a modular system).

For example, when a catastrophic error (CATERR), occurs CPU 302 sends CATERR signal (e.g., CATERR 312) to CPU-state controller 308, and CPU-state controller 308 determines to do a warm reset. CPU-state controller 308 toggles a warm reset signal (e.g., WARM_RESET 314), and CPU-state controller 308 enters a holdoff state while it waits for the warm reset to be completed. as described above for FIG. 1.

Upon completion of the warm reset BIOS 118 causes CPU 302 to assert the GPIO pin (e.g., send GPIO 316)) signaling to CPU-state controller 308 that the fault data collection and logging is complete. CPU-state controller 308 then exits the holdoff state and proceeds that cause the system/card on which CPU 302 is located to be power cycled. The power cycling process can be performed the same as discussed for FIG. 1. As discussed above, for a modular system with multiple cards, CPU-state controller 308 can signal to master controller 110 that the system/card of CPU 302 is to be power cycled, and master controller 110 can control power cycling the card. On the other hand, in a single-card system, CPU-state controller 108 can control power cycling the card.

According to certain non-limiting examples, CPU 302 can be an ×86 CPU. When any of the ×86 cores or any Internal bus logic or I/O controllers detect a catastrophic (CATERR), a dedicated CATERR (also referred to as machine check error (MCERR) or internal error (IERR)) signal is asserted to CPU-state controller 308. For example, when CPU-state controller 308 is informed of this event, CPU-state controller 308 can avoid losing fault data by triggering a warm reset of the CPU by holding off power cycling the card on which CPU 302 is located. The use of the warm reset revives the logic of CPU 302 back to a good state (from the fault state) without losing the state of the MCA banks. Thus, the warm reset enables read-back support of the fault data.

Further, as discussed above, during the warm reset, access to any I/O outside of the CPU is avoided until all the CPU fault data has been collected. Generally, the rest of the components on the board (especially peripheral component interconnect express (PCIe) devices) have not gone through reset and may potentially cause CATERR to recur, if the component that caused the original CATERR is accessed. To mitigate against the CATERR recurring, the fault collection and storing of the fault data in persistent memory is performed in platform BIOS (before peripheral component interconnect express (PCIe) enumeration phase in DXE), instead of how it is performed using the standard Linux kernel.

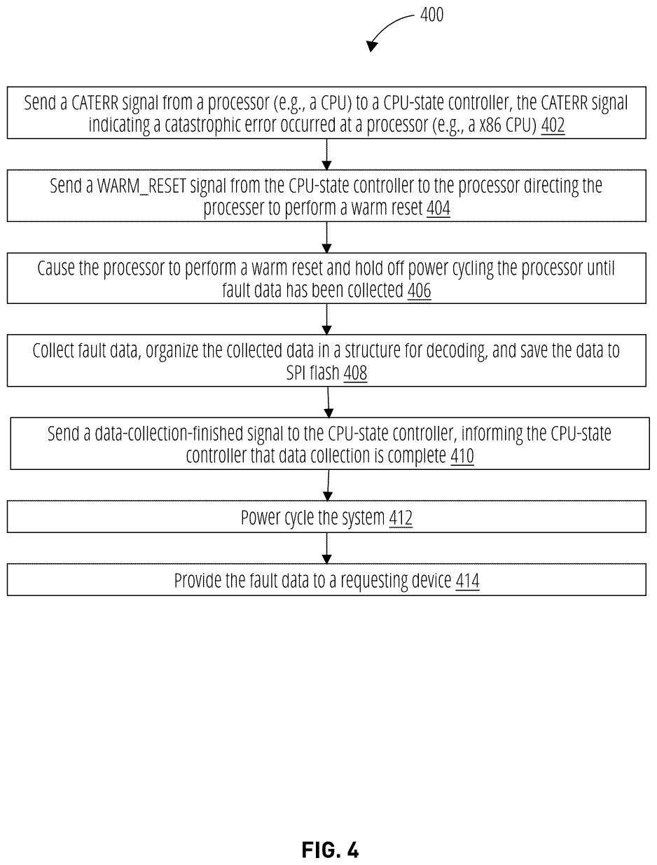

FIG. 4 illustrates an example of method 400 for collecting CPU fault data using a warm reset for system 300. Although the example routine depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

According to some examples, step 402 of the method includes sending a CATERR signal from a processor (e.g., a CPU) to a CPU-state controller, the CATERR signal indicating a catastrophic error occurred at a processor (e.g., a ×86 CPU). For example, CPU 302 illustrated in FIG. 3 may send a CATERR signal to a CPU-state controller 308, and the CATERR signal indicates that a catastrophic error occurred at CPU 302.

According to some examples, step 404 of the method includes sending a WARM_RESET signal from the CPU-state controller to the processor, thereby directing the processor to perform a warm reset at step 404. For example, CPU-state controller 308 illustrated in FIG. 3 may send WARM_RESET 314 from CPU-state controller 308 to CPU 302, thereby directing CPU 302 to perform a warm reset.

According to some examples, step 406 of the method includes causing the processor to perform a warm reset and hold off power cycling the processor until fault data has been collected at step 406. For example, CPU-state controller 308 illustrated in FIG. 3 can toggle warm reset, hold off power cycling CPU 302 until fault data has been collected by BIOS post warm reset.

According to some examples, step 408 of the method includes collecting fault data, organizing the collected data in a structure for decoding, and saving the data to SPI flash at step 408. For example, BIOS 318 illustrated in FIG. 3 may collect the fault data, organize the collected data in a structure for decoding, and save the fault data to SPI flash 306. Step 408 can be performed the same as step 208.

According to some examples, step 410 of the method includes sending a data-collection-finished signal to the CPU-state controller, informing the CPU-state controller that data collection is complete. For example, CPU 302 illustrated in FIG. 3 may send a data-collection-finished signal (e.g., GPIO 316) to CPU-state controller 308, informing CPU-state controller 308 that the collection of the CPU fault data is complete. Step 410 can be performed the same as step 210.

According to some examples, step 412 of the method includes power cycling the system. For example, CPU-state controller 308 illustrated in FIG. 3 may power cycle the system. Either the CPU-state controller or a master controller cycles the system, depending on the type of system. Step 412 can be performed the same as step 212.

According to some examples, step 414 of the method includes providing the fault data to a requesting device. For example, SPI flash 306 illustrated in FIG. 3 may provide the fault data to the requesting device. Step 414 can be performed the same as step 214.

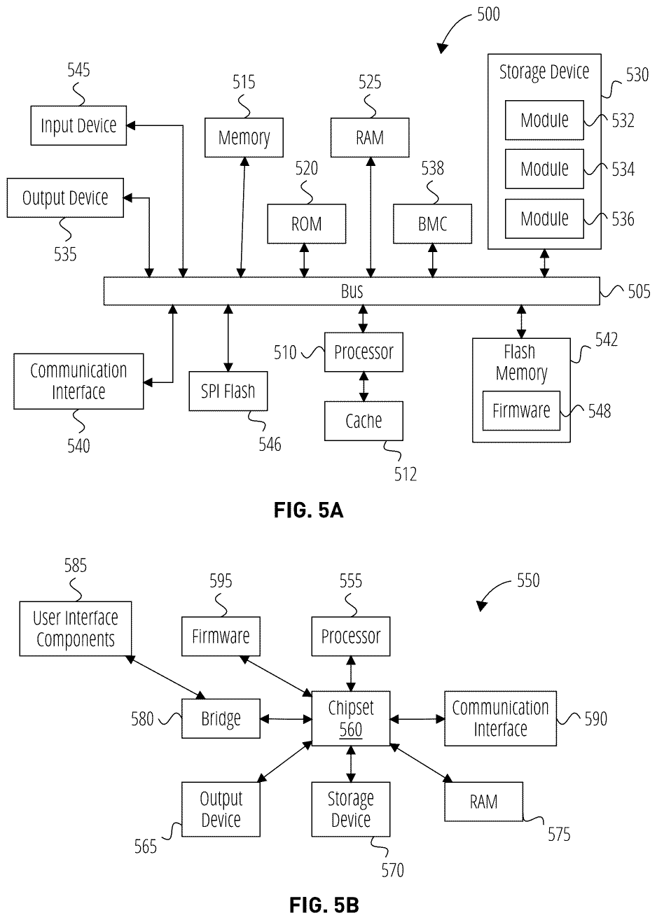

FIG. 5A and FIG. 5B illustrate examples of systems in accordance with some embodiments. For example, the illustrated systems may correspond to one or more computing devices illustrated in system 100 of FIG. 1 or system 300 of FIG. 3. Persons of ordinary skill in the art will also readily appreciate that other system embodiments are possible.

FIG. 5A illustrates an example architecture for a conventional bus computing system 500 where the components of the system are in electrical communication with each other using a bus 505. The computing system 500 includes a processing unit (CPU or processor) 510 and a system bus 505 that couples various system components, including the system memory 515, such as read only memory (e.g., ROM 520) and random access memory (e.g., RAM 525), to the processor 510. The computing system 500 can include a cache 512 of high-speed memory connected directly with, close to, or integrated as part of the processor 510. The computing system 500 can copy data from the memory 515 and/or the storage device 530 to the cache 512 for quick access by the processor 510. Thus, the cache 512 can provide a performance boost that avoids processor 510 delays while waiting for data. These and other modules can control or be configured to control the processor 510 to perform various actions. Other system memory 515 may be available for use as well. Memory 515 can include multiple different types of memory with different performance characteristics. The processor 510 can include any general-purpose processor and a hardware module or software module, such as module 532, module 534, and module 536 stored in storage device 530, configured to control the processor 510 as well as a special-purpose processor where software instructions are incorporated into the actual processor design. The processor 510 may essentially be a completely self-contained computing system, containing multiple cores or processors, a bus, a memory controller, a cache, etc. A multi-core processor may be symmetric or asymmetric.

To enable user interaction with the computing system 500, an input device 545 can represent any number of input mechanisms, such as a microphone for speech, a touch-sensitive screen for gesture or graphical input, keyboard, mouse, motion input, speech, and so forth. An output device 535 can also be one or more of a number of output mechanisms known to those of skill in the art. In some instances, multimodal systems can enable a user to provide multiple types of input to communicate with the computing system 500. The communications interface 540 can generally govern and manage the user input and system output. There is no restriction on operating on any particular hardware arrangement, and, therefore, the basic features here may easily be substituted for improved hardware or firmware arrangements as they are developed.

Storage device 530 is a non-volatile memory and can be a hard disk or other types of computer readable media which can store data that are accessible by a computer, such as magnetic cassettes, flash memory cards, solid state memory devices, digital versatile disks, cartridges, RAM 525, ROM 520, and hybrids thereof.

The storage device 530 can include software modules (e.g., module 532, module 534, and module 536) for controlling the processor 510. Other hardware or software modules are contemplated. The storage device 530 can be connected to the system bus 505. In one aspect, a hardware module that performs a particular function can include the software component stored in a computer-readable medium in connection with the necessary hardware components, such as the processor 510, bus 505, and so forth, to carry out the function.

The BMC (baseboard management controller) 538 can be a specialized microcontroller or processor on the system 500. In some cases, the BMC 538 can be part of an Intelligent Platform Management Interface (IPMI). Moreover, in some cases, the BMC 538 can be embedded on a motherboard or main circuit board of the system 500. The BMC 538 can manage the interface between system management software and platform hardware. Different types of sensors built into the computing system 500 can report to the BMC 538 on parameters such as temperature, cooling fan speeds, power status, operating system (OS) status, and so forth. The BMC 538 can monitor the sensors and send alerts to an administrator via a network interface, such as communication interface 540, if any of the parameters do not stay within preset limits or thresholds, indicating a potential failure or error of the computing system 500. The administrator can also remotely communicate with the BMC 538 to take some corrective action, such as resetting or power cycling the computing system 500, to restore functionality.

Computing system 500 can include serial peripheral interface flash (e.g., SPI flash 546), which can be an electronic non-volatile computer storage medium or chip that can be used by the computing system 500 for storage and/or data transfer.

Flash memory 542 can be an electronic non-volatile computer storage medium or chip that can be used by the computing system 500 for storage and/or data transfer. The flash memory 542 can be electrically erased and/or reprogrammed. Flash memory 542 can, for example, include erasable programmable read-only memory (EPROM), electrically erasable programmable read-only memory (EEPROM), read only memory (ROM), non-volatile random access memory (NVRAM), or complementary metal-oxide semiconductor (CMOS). The flash memory 542 can store the firmware 548 executed by the computing system 500 when the computing system 500 is first powered on, along with a set of configurations specified for the firmware 548. The flash memory 542 can also store configurations used by the firmware 548.

The firmware 548 can include a Basic Input/Output System (BIOS) or its successors or equivalents, such as an Extensible Firmware Interface (EFI) or Unified Extensible Firmware Interface (UEFI). The firmware 548 can be loaded and executed as a sequence program each time the computing system 500 is started. The firmware 548 can recognize, initialize, and test hardware present in the computing system 500 based on the set of configurations. The firmware 548 can perform a self-test, such as a Power-on-Self-Test (POST), on the computing system 500. This self-test can test the functionality of various hardware components such as hard disk drives, optical reading devices, cooling devices, memory modules, expansion cards and the like. The firmware 548 can address and allocate an area in the memory 515, ROM 520, RAM 525, and/or storage device 530, to store an operating system (OS). The firmware 548 can load a boot loader and/or OS, and give control of the computing system 500 to the OS.

The firmware 548 of the computing system 500 can include a firmware configuration that defines how the firmware 548 controls various hardware components in the computing system 500. The firmware configuration can determine the order in which the various hardware components in the computing system 500 are started. The firmware 548 can provide an interface, such as an UEFI, that allows various parameters to be set, which can be different from parameters in a firmware default configuration. For example, a user (e.g., an administrator) can use the firmware 548 to specify clock and bus speeds, define what peripherals are attached to the computing system 500, set monitoring of health (e.g., fan speeds and CPU temperature limits), and/or provide a variety of other parameters that affect overall performance and power usage of the computing system 500.

While firmware 548 is illustrated as being stored in the flash memory 542, one of ordinary skill in the art will readily recognize that the firmware 548 can be stored in other memory components, such as memory 515 or ROM 520. However, firmware 548 is illustrated as being stored in flash memory 542 as a non-limiting example for explanation purposes.

FIG. 5B illustrates another example computer system 550 having a chipset architecture that can be used in executing the described method(s) or operations. Computer system 550 can include computer hardware, software, and firmware that can be used to implement the disclosed technology. Computer system 550 can include a processor 555, representative of any number of physically and/or logically distinct resources capable of executing software, firmware, and hardware configured to perform identified computations. Processor 555 can communicate with a chipset 560 that can control input to and output from processor 555. In this example, chipset 560 outputs information to output 565, such as a display, and can read and write information to storage device 570, which can include magnetic media, and solid state media, for example. Chipset 560 can also read data from and write data to RAM 575. A bridge 580 for interfacing with a variety of user interface components 585 can be provided for interfacing with chipset 560. Such user interface components 585 can include a keyboard, a microphone, touch detection and processing circuitry, a pointing device, such as a mouse, and so on. In general, inputs to system 550 can come from any of a variety of sources, machine generated and/or human generated.

Chipset 560 can also interface with one or more communication interfaces 590 that can have different physical interfaces. Such communication interfaces can include interfaces for wired and wireless local area networks, for broadband wireless networks, as well as personal area networks. Further, the machine can receive inputs from a user via user interface components 585 and execute appropriate functions, such as browsing functions by interpreting these inputs using processor 555.

Moreover, chipset 560 can also communicate with firmware 595, which can be executed by the computer system 550 when powering on. The firmware 595 can recognize, initialize, and test hardware present in the computer system 550 based on a set of firmware configurations. The firmware 595 can perform a self-test, such as a POST, on the system 550. The self-test can test functionality of the various hardware components shown in FIG. 5B. The firmware 595 can address and allocate an area in the memory (e.g., RAM 575) to store an OS. The firmware 595 can load a boot loader and/or OS, and give control of the system 550 to the OS. In some cases, the firmware 595 can communicate with the hardware components. Here, the firmware 595 can communicate with the hardware components through the chipset 560 and/or through one or more other components. In some cases, the firmware 595 can communicate directly with the hardware components.

It can be appreciated that example computer systems 500 and 550 can have more than one processor 510 or be part of a group or cluster of computing devices networked together to provide greater processing capability.

For clarity of explanation, in some instances, the present technology may be presented as including individual functional blocks, including functional blocks comprising devices, device components, steps, or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program, or a collection of programs that carry out a specific function. In some embodiments, a service can be considered a server. The memory can be a non-transitory computer-readable medium.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, For example, instructions and data which cause or otherwise configure a general purpose computer, special purpose computer, or special purpose processing device to perform a certain function or group of functions. Portions of computer resources used can be accessible over a network. The computer executable instructions may be, For example, binaries, intermediate format instructions such as assembly language, firmware, or source code. Examples of computer-readable media that may be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

### Aspects

The present technology includes computer-readable storage mediums for storing instructions, and systems for executing any one of the methods embodied in the instructions addressed in the aspects of the present technology presented below:

Aspect 1. A method for recovering from a fatal fault event, the method comprising: obtaining, at a processor, a fatal-fault-event signal indicating a fault state occurred within a system of the processor; sending, from the processor to a state controller, one or more first signals indicating an occurrence of the fault state, the one or more first signals causing the state controller to be in a power-cycle-holdoff state; and performing a warm reset of the processor by: causing, in response to the fatal-fault-event signal, an execution of a part of a boot sequence that restores the processor to a non-fault state while preserving fault data in registers within the processor; collecting, by a BIOS (basic input/output system), the fault data in the registers; and logging the fault data in a persistent memory storage.

Aspect 2. The method of aspect 1, wherein: the warm reset of the processor is triggered either by warm reset of the processor either via a system management unit (SMU) provided in firmware of the processor or by the state controller, and the registers are fault registers.

Aspect 3. The method of any of aspects 1-2, wherein: the persistent memory storage is a serial peripheral interface flash memory, the processor is an ×86 central processing unit (CPU), the registers comprise machine check architecture banks; and the state controller is a finite state machine that having CPU-state logic encoded in a field programable gate array, an application specific integrated circuit, or a combination of discrete logic components.

Aspect 4. The method of any of aspects 1-3, further comprising signaling that the system of the processor is ready to be power cycled by: de-asserting, by the state controller, a processor-ready status, and asserting, by the state controller, a fatal-fault-event status.

Aspect 5. The method of any of aspects 1-4, further comprising: sending, from the processor to the state controller, a second signal upon completion of the warm reset, the second signal indicating that the collecting of the fault data and the logging of the fault data is complete, wherein sending the one or more first signals to the state controller indicates that the fault state is the fatal fault event.

Aspect 6. The method of aspect 5, further, comprising: timing, by the state controller, a duration from when the one or more first signals are received at the state controller; and transitioning the state controller from the power-cycle-holdoff state to a power-cycle-allowed state indicating an end to holding off power cycling the system of the processor, wherein the state controller is transitioned to the power-cycle-allowed state in response to at least one of the duration exceeding a predefined timeout value or receiving the second signal at the state controller.

Aspect 7. The method of aspect 5, further comprising: receiving, from the state controller to the processor, an instruction to power cycle the system of the processor, wherein the system of the processor is a single-card system having one card to which the processor is fixed.

Aspect 8. The method of aspect 5, further comprising: receiving, at a master controller from the state controller, a third signal indicating that the fatal-fault-event signal was obtained; and in response to the third signal performing, by the master controller, steps of: writing the fault data from the persistent memory storage to a system storage, and receiving, at the processor from the master controller, an instruction to power cycle a card of the processor, wherein the system of the processor is a multi-card system having two or more cards including the card of the processor.

Aspect 9. The method of any of aspects 1-8, further comprising: receiving, at firmware of the processor, an indicator that the BIOS has a functionality to collect the fault data; responsive to the indicator, enabling a warm reset to be triggered upon receiving the fatal-fault-event signal, and receiving, at the firmware, the fatal-fault-event signal and, in response to receiving the fatal-fault-event signal, triggering the warm reset and indicating to BIOS that the warm reset has been triggered to cause the collecting and logging of the fault data upon a subsequent boot iteration, wherein the one or more first signals are sent to the state controller in response to the firmware receiving the fatal-fault-event signal.

Aspect 10. The method of aspect 9, further comprising: sending, from the processor to the state controller, a second signal upon completion of the collecting of the fault data and the logging of the fault data, the second signal comprises toggling a voltage on a general-purpose input/output pin to high, wherein the one or more first signals are sent to the state controller in response to the processor obtaining the fatal-fault-event signal, and the one or more first signals comprise an alert signal and reset signal.

Aspect 11. The method of any of aspects 1-10, wherein performing the part of the boot sequence includes that the part of the boot sequence omits a part of a full boot sequence accessing input/output data from components outside of the processor and the part of the boot sequence omits parts of the full boot sequence in which the processor accesses data from one or more peripheral component interconnect express devices that have not been reset since the fault state occurred.

Aspect 12. A non-transitory computer readable medium comprising one or more sequences of instructions, which, when executed by a processor, cause a computing system associated with a content management system to perform operations of the method of any of aspects 1-11.

Aspect 13. A generative response system comprising: one or more processors; and a memory having programming instructions stored thereon, which, when executed by the one or more processors, causes the content management system to perform operations of the method of any of aspects 1-11.

What is claimed is:

1. A method for recovering from a fatal fault event, the method comprising:
obtaining, at a processor, a fatal-fault-event signal indicating a fault state occurred within a system of the processor;
sending, from the processor to a state controller, one or more first signals indicating an occurrence of the fault state, the one or more first signals causing the state controller to be in a power-cycle-holdoff state; and
performing a warm reset of the processor by:
causing, in response to the fatal-fault-event signal, an execution of a part of a boot sequence that restores the processor to a non-fault state while preserving fault data in registers within the processor;
collecting, by a BIOS (basic input/output system), the fault data in the registers; and
logging the fault data in a persistent memory storage.

2. The method of claim 1, wherein:
the warm reset of the processor is triggered either by warm reset of the processor either via a system management unit (SMU) provided in firmware of the processor or by the state controller, and
the registers are fault registers.

3. The method of claim 1, wherein:
the persistent memory storage is a serial peripheral interface flash memory,
the processor is an ×86 central processing unit (CPU),
the registers comprise machine check architecture banks; and
the state controller is a finite state machine that having CPU-state logic encoded in a field programable gate array, an application specific integrated circuit, or a combination of discrete logic components.

4. The method of claim 1, further comprising signaling that the system of the processor is ready to be power cycled by:
de-asserting, by the state controller, a processor-ready status, and
asserting, by the state controller, a fatal-fault-event status.

5. The method of claim 1, further comprising:
sending, from the processor to the state controller, a second signal upon completion of the warm reset, the second signal indicating that the collecting of the fault data and the logging of the fault data is complete,
wherein sending the one or more first signals to the state controller indicates that the fault state is the fatal fault event.

6. The method of claim 5, further, comprising:
timing, by the state controller, a duration from when the one or more first signals are received at the state controller; and
transitioning the state controller from the power-cycle-holdoff state to a power-cycle-allowed state indicating an end to holding off power cycling the system of the processor, wherein the state controller is transitioned to the power-cycle-allowed state in response to at least one of the duration exceeding a predefined timeout value or receiving the second signal at the state controller.

7. The method of claim 5, further comprising:
receiving, from the state controller to the processor, an instruction to power cycle the system of the processor,
wherein the system of the processor is a single-card system that includes the processor.

8. The method of claim 5, further comprising:
receiving, at a master controller from the state controller, a third signal indicating that the fatal-fault-event signal was obtained; and
in response to the third signal performing, by the master controller, steps of:
writing the fault data from the persistent memory storage to a system storage, and
receiving, at the processor from the master controller, an instruction to power cycle a card of the processor,
wherein the system of the processor is a multi-card system having two or more cards including the card of the processor.

9. The method of claim 1, further comprising:
receiving, at firmware of the processor, an indicator that the BIOS has a functionality to collect the fault data;
responsive to the indicator, enabling a warm reset to be triggered upon receiving the fatal-fault-event signal, and
receiving, at the firmware, the fatal-fault-event signal and, in response to receiving the fatal-fault-event signal, triggering the warm reset and indicating to BIOS that the warm reset has been triggered to cause the collecting and logging of the fault data upon a subsequent boot iteration,
wherein the one or more first signals are sent to the state controller in response to the firmware receiving the fatal-fault-event signal.

10. The method of claim 9, further comprising:
sending, from the processor to the state controller, a second signal upon completion of the collecting of the fault data and the logging of the fault data, the second signal comprises toggling a voltage on a general-purpose input/output pin to high,
wherein the one or more first signals are sent to the state controller in response to the processor obtaining the fatal-fault-event signal, and the one or more first signals comprise an alert signal and reset signal.

11. The method of claim 1, wherein performing the part of the boot sequence includes that the part of the boot sequence omits a part of a full boot sequence accessing input/output data from components outside of the processor and the part of the boot sequence omits parts of the full boot sequence in which the processor accesses data from one or more peripheral component interconnect express devices that have not been reset since the fault state occurred.

12. A computing system that recovers from a fatal fault event, the computing system comprising:
a processor executing a BIOS (basic input/output system);
a state controller comprising CPU-state logic that controls a state of the processor; and
a plurality of memories comprising a persistent memory and a BIOS memory, the plurality of memories storing instructions that, when executed by the processor, configure the computing system to:
obtain, at the processor, a fatal-fault-event signal indicating a fault state occurred within the computing system;
send, from the processor to the state controller, one or more first signals indicating an occurrence of the fault state, the one or more first signals causing the state controller to be in a power-cycle-holdoff state; and
perform a warm reset of the processor by:
causing, in response to the fatal-fault-event signal, an execution of a part of a boot sequence restoring the processor to a non-fault state and preserving fault data in registers within the processor,
collecting, by the BIOS, the fault data in the registers, and
logging the fault data in a persistent memory storage.

13. The computing system of claim 12, wherein:
the persistent memory storage is a serial peripheral interface flash memory,
the processor is an ×86 central processing unit (CPU),
the registers comprise machine check architecture banks; and
the state controller is a finite state machine that having CPU-state logic encoded in a field programable gate array, an application specific integrated circuit, or a combination of discrete logic components.

14. The computing system of claim 12, wherein the instructions further configure the computing system to:
send, from the processor to the state controller, a second signal upon completion of the collecting of the fault data and the logging of the fault data, the second signal indicating that the warm reset is complete,
wherein sending the one or more first signals to the state controller indicates that the fault state is the fatal fault event.

15. The computing system of claim 14, wherein the state controller is configured to:
time, by the state controller, a duration from when the one or more first signals are received at the state controller; and
the state controller from the power-cycle-holdoff state to a power-cycle-allowed state indicating an end to holding off power cycling the computing system, wherein the state controller is transitioned to the power-cycle-allowed state in response to at least one of the duration exceeding a predefined timeout value or receiving the second signal at the state controller.

16. The computing system of claim 14, wherein the instructions further configure the computing system to:
receive, from the state controller to the processor, an instruction to power cycle the computing system,
wherein the computing system is a single-card system that includes the processor.

17. The computing system of claim 12, wherein the instructions further configure the computing system to:
receive, at firmware of the processor, an indicator that the BIOS has a functionality to perform the collecting of the fault data and the logging of the fault data; and
receive, at the firmware, the fatal-fault-event signal and, in response to receiving the fatal-fault-event signal, send an instruction to the BIOS to trigger the warm reset,
wherein the one or more first signals are sent to the state controller in response to the firmware receiving the fatal-fault-event signal.

18. The computing system of claim 17, wherein the instructions further configure the computing system to:
send, from the processor to the state controller, a second signal upon completion of the collecting of the fault data and the logging of the fault data, the second signal comprises toggling a voltage on a general-purpose input/output pin to high,
wherein the one or more first signals are sent to the state controller in response to the processor obtaining the fatal-fault-event signal, and the one or more first signals comprise an alert signal and reset signal.

19. The computing system of claim 12, wherein performing the part of the boot sequence includes that the part of the boot sequence omits a part of a full boot sequence accessing input/output data from components outside of the processor and the part of the boot sequence omits parts of the full boot sequence in which the processor accesses data from one or more peripheral component interconnect express devices that have not been reset since the fault state occurred.

20. A non-transitory computer-readable storage medium, the non-transitory computer-readable storage medium comprising instructions for recovering from a fatal fault event) that when executed by a computing system, cause the computing system to:
obtain a fatal-fault-event signal indicating a fault state occurred within the computing system, the computing system comprising a processor;
send, from the processor to a state controller, one or more first signals indicating an occurrence of the fault state, the one or more first signals causing the state controller to be in a power-cycle-holdoff state; and
perform a warm reset of the processor by:
causing, in response to the fatal-fault-event signal, an execution of a part of a boot sequence restoring the processor to a non-fault state and preserving fault data in registers within the processor;
collecting, by a basic input/output system (BIOS), the fault data in registers; and
logging the fault data in a persistent memory storage.
